(19) United States
(12) Patent Application Publication
(10) Pub. No.: US 2018/0150837 A1
(43) Pub. Date: May 31, 2018

(54) SYSTEM AND METHOD FOR DELIVERING A CASHLESS GIFT USEABLE DURING A CASHLESS TRANSACTION

(71) Applicant: MASTERCARD INTERNATIONAL INCORPORATED, Purchase, NY (US)

(72) Inventors: Sean Kirch, Mahwah, NJ (US); Vijaykrishna Lakshminarayanan, Dobbs Ferry, NY (US); Girish Pandey, Valhalla, NY (US)

(21) Appl. No.: 15/363,158

(22) Filed: Nov. 29, 2016

(51) Int. Cl. G06Q 20/40; G06Q 20/12

(52) U.S. Cl. CPC G06Q 20/405; G06Q 20/12

(57) ABSTRACT

A system and method to enable a gifter to surprise a recipient with a gift. The gifter, having access to certain information about the recipient, is able to set up a gift to the recipient via a gift web site, setting criteria for the gift. For example, the gifter may provide a gift for a predetermined amount that is redeemable at any merchant or merchant website. Alternatively, the gifter may provide a gift for a predetermined amount that may be redeemed only at a specific merchant or a specific merchant website. Still alternatively, the gifter may provide a gift the permits the intended gift recipient to purchase a predetermined number of items from any merchant or from a specific merchant. In this way the gifter provides a surprise gift to a gift recipient.

### FIELD OF THE INVENTION

The present invention relates to a system and method for delivering a cashless gift useable during a cashless transaction.

### BACKGROUND OF THE INVENTION

Existing gifting options for cashless transactions are limited to digital or physical gift cards that can be purchased and then delivered to a gift recipient. Gifts of this type have become so common-place that they have lost some of the excitement associated with giving and receiving gifts—namely, the element of surprise. The surprise associated with receiving a gift may come in one of two ways: a completely unexpected gift (e.g., one not associated with a holiday, birthday, special occasion, etc.), and an expected gift, where what the gift itself is the surprise. However, it is currently not possible to send surprise gifts to friends, family, colleagues, etc. either in at a time determined by the gifter, or during a cashless transaction—each instance presenting a surprise gift to the gift recipient. In addition, current digital or physical gift cards cannot tailor the gift to an intended recipient's actual spending habits and patterns.

Thus there exists a need for a solution to the above-identified shortcomings of the prior art.

### SUMMARY OF THE INVENTION

The present invention is directed to a system and method to enable a gifter to surprise a recipient with a gift. As a first step, the recipient preferably has at least one cashless transaction card account and account number, and has previously provided authorization to the issuer (e.g., their bank) of that account to share certain of the recipient's information with others. The gifter, having access to certain information about the recipient, is able to set up a gift to the recipient via a gift web site. In the process of setting up a gift, the gifter may gain access to information about the recipient, depending upon whether the recipient has previously authorized the issuer to share such information. The information to which the gifter may gain access can include the recipient's shopping habits, i.e., where the recipient has recently shopped and what was purchased (either itemized or generally categorized), favorite merchants (based upon the recipient's shopping history or as identified by the recipient), and other information about the recipient's shopping habits and trends. With this information the gifter is able to set criteria for the gift. For example, the gifter may provide a cash gift, a credit gift, or a gift for a predefined number of items. In each case, either a discrete limit, or a range, may be defined by the gifter. The gifts may be redeemable at any merchant or merchant website, or only at a specific merchant or a specific merchant website, as selected by the gifter. Other variations are contemplated by, and within the scope and spirit of the present invention.

The gifter may choose the timing for delivery of the gift. For example, the gifter may choose that the gift be delivered during a check-out procedure when the recipient has completed shopping at a specific merchant or on a specific merchant web-site using his/her cashless transaction card. Alternatively, the gifter may select that the gift be delivered when the intended gift recipient next uses his/her cashless transaction card at any merchant or website. Still alternatively, the gifter may select that the gift be delivered at a certain date, e.g., on an intended gift recipient's birthday. In every case, the gift will be applied to a cashless transaction entered into by the intended gift recipient. For example, for a gift in the form of a set dollar amount (i.e., cash) or credit at a specific merchant, the present invention causes the terms of the cashless transaction to be modified to reduce the cost to the gift recipient of the cashless transaction according to the gift conditions and limitations. Similarly, the present invention causes a gift for a predetermined number of items to modify the terms of the cashless transaction so the intended gift recipient will not pay for these items. In any case, the present invention enables a gifter to create and deliver to an intended gift recipient a surprise electronic gift usable by the recipient according to conditions and limitations defined by the gifter. Based upon the type and amount of information made available to the gifter, the gift can be set for either specific merchants, products or MCC (merchant category code) class(es), or it may be set for any merchant, product or mcc class(es). When the gifter has access to the recipient's shopping and spending habits, i.e., insights about the recipient's use of a cashless transaction card, the gifter can tailor the gift based upon such insights.

The present invention may be embodied as a system, method, or combination thereof.

An embodiment of the present invention is directed to a system for delivering a cashless gift useable during a cashless transaction between a merchant and a customer using a cashless transaction account number. The system comprises a gift database having a plurality of database entries, each of the plurality of database entries being for a gift created by a gifter, each gift corresponding to a cashless transaction account number and having at least one gift condition and at least one gift limitation. The system further comprises a server having a processor operable by a program of instructions stored in memory, the server being connectable to the gift database and at least one of a point of sale terminal and a merchant website. The program of instructions, when executed by the server processor, causes the server processor, during a cashless transaction, to receive an initiation of the cashless transaction for the customer cashless transaction account number; determine if there is an entry in the gift database corresponding to the customer cashless transaction account number; if there is an entry in the gift database corresponding to the customer cashless transaction account number, determine if the at least one gift condition has been met; determine if the customer has accepted the gift; if the customer has accepted the gift, apply, to and during the cashless transaction, at least one of the at least one gift condition and the at least one gift limitation; and update the entry in the gift database corresponding to the customer cashless transaction account number.

An embodiment of the present invention is further directed to a system for delivering a cashless gift useable during a cashless transaction, wherein the at least one gift condition identifies a location at which the gift may be redeemed, and wherein the location comprises one of a merchant location, a merchant website, a favorite merchant of the customer, a favorite website of the customer, a merchant selected by the gifter, and a website selected by the gifter.

An embodiment of the present invention is further directed to a system for delivering a cashless gift useable during a cashless transaction, wherein the at least one gift condition defines a type of gift, and wherein the type of gift comprises one of a fixed monetary amount gift, a fixed credit amount gift, and a fixed number of items gift.

An embodiment of the present invention is further directed to a system for delivering a cashless gift useable during a cashless transaction, wherein the type of gift comprises a fixed monetary amount gift delivered to the customer at a time chosen by the gifter and usable by the customer during the cashless transaction at one of a merchant chosen by the customer and a merchant chosen by the gifter, wherein the fixed monetary amount is applied during the cashless transaction to reduce the amount of the cashless transaction by the fixed monetary amount.

An embodiment of the present invention is further directed to a system for delivering a cashless gift useable during a cashless transaction, wherein the gift limitation comprises one of a maximum dollar amount and a dollar range.

An embodiment of the present invention is further directed to a system for delivering a cashless gift useable during a cashless transaction, wherein the gift is delivered to the customer in advance of the initiation of the cashless transaction.

An embodiment of the present invention is further directed to a system for delivering a cashless gift useable during a cashless transaction, wherein the type of gift comprises a fixed credit amount gift delivered to the during the cashless transaction and usable by the customer during the cashless transaction at one of a merchant chosen by the customer and merchant chosen by the gifter, wherein the fixed credit amount is applied as a credit to the cardholder cashless transaction account number.

An embodiment of the present invention is further directed to a system for delivering a cashless gift useable during a cashless transaction, wherein the gift limitation comprises one of a maximum dollar amount and a dollar range.

An embodiment of the present invention is further directed to a system for delivering a cashless gift useable during a cashless transaction, wherein the type of gift comprises a fixed number of items gift delivered to the customer during the cashless transaction and usable by the customer during a cashless transaction at one of a merchant chosen by the customer and merchant chosen by the gifter, wherein the fixed number of items gift is applied during the cashless transaction to reduce the amount owed by the customer for the cashless transaction to zero for a number of items defined by the fixed number of items gift.

An embodiment of the present invention is further directed to a system for delivering a cashless gift useable during a cashless transaction, wherein the gift limitation comprises one of a maximum number of items and a number range of items.

An embodiment of the present invention is further directed to a system for delivering a cashless gift useable during a cashless transaction, wherein the at least one gift condition defines a product category comprising one of a favorite product category of the customer and a product category selected by the gifter.

An embodiment of the present invention is further directed to a system for delivering a cashless gift useable during a cashless transaction, wherein the program of instructions, when executed by the server processor, further causes the server processor to provide a gift website and receive from a gifter accessing the gift website first information about a gift recipient; transmit the first information to a bank of the gift recipient; receive from the bank of the gift recipient second information about the gift recipient; receive, from the gifter via the gift website, terms for a gift for the gift recipient; and create a record in the gift database for the gift.

Another embodiment of the present invention is directed to a system for delivering a cashless gift useable during a cashless transaction between a merchant and a customer using a cashless transaction account number. The system of this embodiment comprises a gift database having a plurality of database entries, each of the plurality of database entries being for a gift created by a gifter, each gift corresponding to a cashless transaction account number and having at least one temporal condition, at least one gift condition, and at least one gift limitation. The system of this embodiment further comprises a server having a processor operable by a program of instructions stored in memory, the server being connectable to the gift database and at least one of a point of sale terminal and a merchant website. The program of instructions, when executed by the server processor, causes the server processor to determine if the temporal condition has been met; determine if the customer has accepted the gift; if the customer has accepted the gift, transmit a gift token to the gift recipient; during a cashless transaction, when the customer uses the gift token, apply at least one of the at least one gift condition and the at least one gift limitation; and update the entry in the gift database corresponding to the customer cashless transaction account number.

An embodiment of the present invention is further directed to a system for delivering a cashless gift useable during a cashless transaction, wherein the at least one temporal condition is one of a date and a range of dates.

An embodiment of the present invention is further directed to a system for delivering a cashless gift useable during a cashless transaction, wherein the at least one gift condition defines a type comprising one of a fixed monetary amount gift, a fixed credit amount gift, and a fixed number of items gift.

An embodiment of the present invention is further directed to a system for delivering a cashless gift useable during a cashless transaction, wherein the type of gift comprises a fixed monetary amount gift delivered to the customer at a time chosen by the gifter and usable by the customer during the cashless transaction at one of a merchant chosen by the customer and a merchant chosen by the gifter, wherein the fixed monetary amount is applied during the cashless transaction to reduce the amount of the cashless transaction by the fixed monetary amount.

An embodiment of the present invention is further directed to a system for delivering a cashless gift useable during a cashless transaction, wherein the gift limitation comprises one of a maximum dollar amount and a dollar range.

An embodiment of the present invention is further directed to a system for delivering a cashless gift useable during a cashless transaction, wherein the type of gift comprises a fixed credit amount gift delivered to the during the cashless transaction and usable by the customer during the cashless transaction at one of a merchant chosen by the customer and merchant chosen by the gifter, wherein the fixed credit amount is applied as a credit to the cardholder cashless transaction account number.

An embodiment of the present invention is further directed to a system for delivering a cashless gift useable during a cashless transaction, wherein the gift limitation comprises one of a maximum dollar amount and a dollar range.

An embodiment of the present invention is further directed to a system for delivering a cashless gift useable during a cashless transaction, wherein the type of gift comprises a fixed number of items gift delivered to the customer during the cashless transaction and usable by the customer during a cashless transaction at one of a merchant chosen by the customer and merchant chosen by the gifter, wherein the fixed number of items gift is applied during the cashless transaction to reduce the amount owed by the customer for the cashless transaction to zero for a number of items defined by the fixed number of items gift.

An embodiment of the present invention is further directed to a system for delivering a cashless gift useable during a cashless transaction, wherein the gift limitation comprises one of a maximum number of items and a number range of items.

An embodiment of the present invention is further directed to a system for delivering a cashless gift useable during a cashless transaction, wherein the at least one gift condition defines a product category comprising one of a favorite product category of the customer and a product category selected by the gifter.

An embodiment of the present invention is further directed to a system for delivering a cashless gift useable during a cashless transaction, wherein the at least one gift condition identifies a location at which the gift may be redeemed, and wherein the location comprises one of a merchant location, a merchant website, a favorite merchant of the customer, a favorite website of the customer, a merchant selected by the gifter, and a website selected by the gifter.

An embodiment of the present invention is further directed to a system for delivering a cashless gift useable during a cashless transaction, wherein the program of instructions, when executed by the server processor, further causes the server processor to provide a gift website and receive from a gifter accessing the gift website first information about a gift recipient; transmit the first information to a bank of the gift recipient; receive from the bank of the gift recipient second information about the gift recipient; receive, from the gifter via the gift website, terms for a gift for the gift recipient; and create a record in the gift database for the gift.

### DESCRIPTION OF THE DRAWINGS

Embodiments of the present invention will now be described with reference to the following drawings, wherein:

FIG. 1 depicts a system for delivering a cashless gift useable during a cashless transaction between a merchant and a customer, including certain devices and components configured in accordance with embodiments of the present invention;

FIGS. 2A-2B are flow diagrams of a gift creation phase in accordance with embodiments of the present invention;

FIGS. 3A-3B are flow diagrams of a gift redemption phase in accordance with embodiments of the present invention;

FIG. 4 is a flow diagram of certain steps carried-out when opening a new cashless transaction card account;

FIGS. 5A-5I depict various images of a gift website in accordance with embodiments of the present invention; and

FIG. 6 is a block-diagram schematic of a server in accordance with embodiments of the present invention.

### DESCRIPTION OF EMBODIMENTS OF THE INVENTION

The following describes exemplary embodiments of the present invention. It should be apparent to those skilled in the art that the described embodiments of the present invention are illustrative only and not limiting, having been presented by way of example only. All features disclosed in this description may be replaced by alternative features serving the same or similar purpose, unless expressly stated otherwise. Therefore, numerous and various other embodiments of the modification thereof are contemplated as falling within the scope of the present invention as defined herein and equivalents thereto.

As used herein the term “cashless transaction” refers to a transaction between at least a merchant and a customer or cardholder (these terms being used interchangeably herein) using a cashless transaction account number associated with a cashless transaction card or cashless transaction account. Typically, an issuer of the cashless transaction card account number is also involved in the transaction to authorize the transaction, to provide payment to the merchant, and to manage the customer's cashless transaction account. The cashless transaction may be initiated using a cashless transaction number associated with a cashless transaction card, or using a device capable of carrying out a cashless transaction with a cashless transaction account number. As used herein, the term “cashless transaction card” includes, by way of illustration and not limitation, a credit card, debit card, gift card, and other similar cards, whether physical, virtual, or as part of an electronic wallet, as is known in the art. References to a cashless transaction card are also intended to refer to an account and account number associated with the cashless transaction card. Thus, reference to a cashless transaction card herein does not only refer to the physical card, but also to the account and account number for that card. As used herein, the term “cashless transaction device” includes an electronic or electro-mechanical device capable of carrying-out aspects of a cashless transaction including, by way of illustration and not limitation, a smart phone, a tablet, a laptop computer, and other similar electronic or electro-mechanical devices.

The terms recipient, intended recipient, customer and cardholder are used interchangeably herein to refer to the person receiving a gift from a gifter. As used herein, the terms “dollar” and “cash” are used to refer to any type and denomination of currency, whether physical or digital, useable to obtain goods and/or services.

Referring next to the drawings in detail, embodiments of the present invention will now be discussed. In general, the system 10 of the present invention enables a gifter to provide to an intended gift recipient a surprise gift having gift conditions previously defined by the gifter. For example, the gifter may provide a cash gift, a credit gift, or a gift for a predefined number of items. In each case, either a discrete limit, or a range may be defined by the gifter. The gifts may be redeemable at any merchant or merchant website, or only at a specific merchant or a specific merchant website, as selected by the gifter. Other variations are contemplated by, and within the scope and spirit of the present invention.

The gifter may select that the gift be delivered in advance digitally or alternatively select that the gift be delivered during a check-out procedure during a cashless transaction. Alternatively, the gifter may set a temporal limitation to deliver the gift when the intended gift recipient next uses his/her cashless transaction card, upon a specified date, or within a specified date range. In every case, the gift will be applied to a cashless transaction entered into by the intended gift recipient. For example, for a gift in the form of a set dollar amount (i.e., cash) or credit, the present invention causes the terms of the cashless transaction to be modified to reduce the cost to the recipient of the cashless transaction by the amount of the gift. Similarly, the present invention causes a gift for a predetermined number of items to modify the terms of the cashless transaction so the intended gift recipient will not pay for these items. In any case, the present invention enables a gifter to create and deliver to an intended gift recipient a surprise electronic gift usable by the recipient according to conditions defined by the gifter.

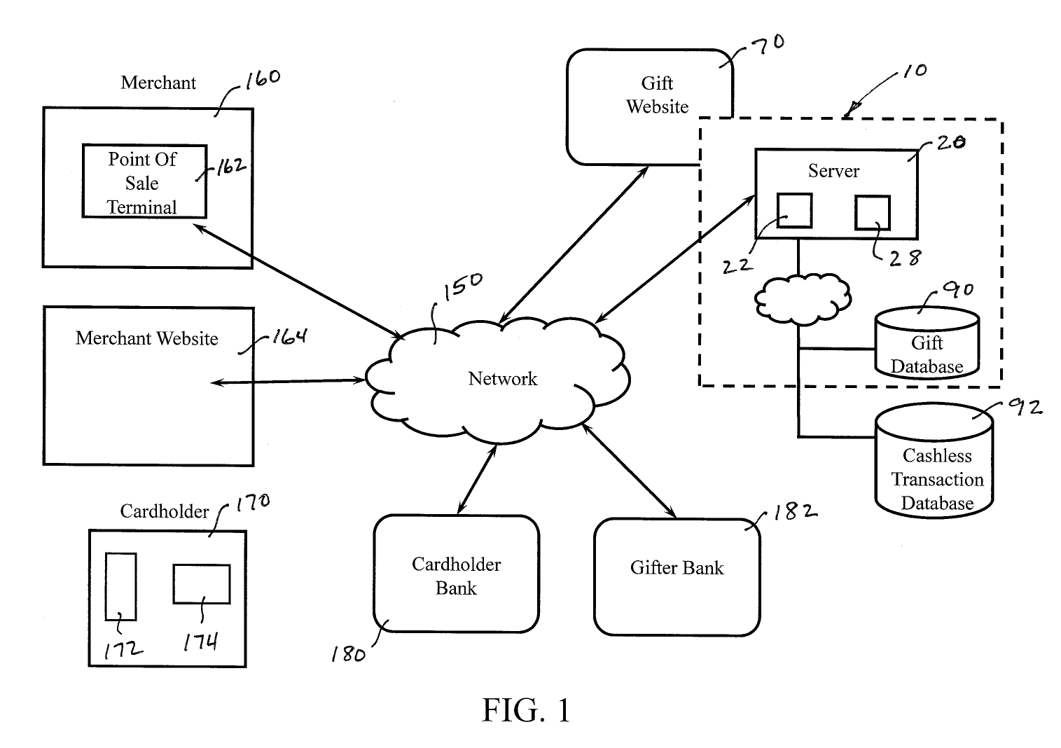

Referring first to FIG. 1, an illustrative configuration of a system 10 in accordance with embodiments is depicted. The system 10 comprises a server 20 connectable to a network 150 that may be any known or hereafter developed network such as, by way of illustration and not limitation, a local area network (“LAN”), the Internet, a wireless network, a cellular network, and variations and combinations thereof. As used herein, the term “connectable” refers to various states of connection between electronic devices. For example, “connectable” refers to a physical connection between electronic devices, a wireless connection between electronic devices, a combination of a physical and wireless connection between electronic devices, or a transient or episodic connection between electronic devices. As used herein, the term “connectable” also refers to various point in time with respect to connectivity between electronic devices such as, by way of non-limiting example, during the time when electronic devices are not connected, during the time when electronic devices are connecting, and during the time when electronic devices are connected.

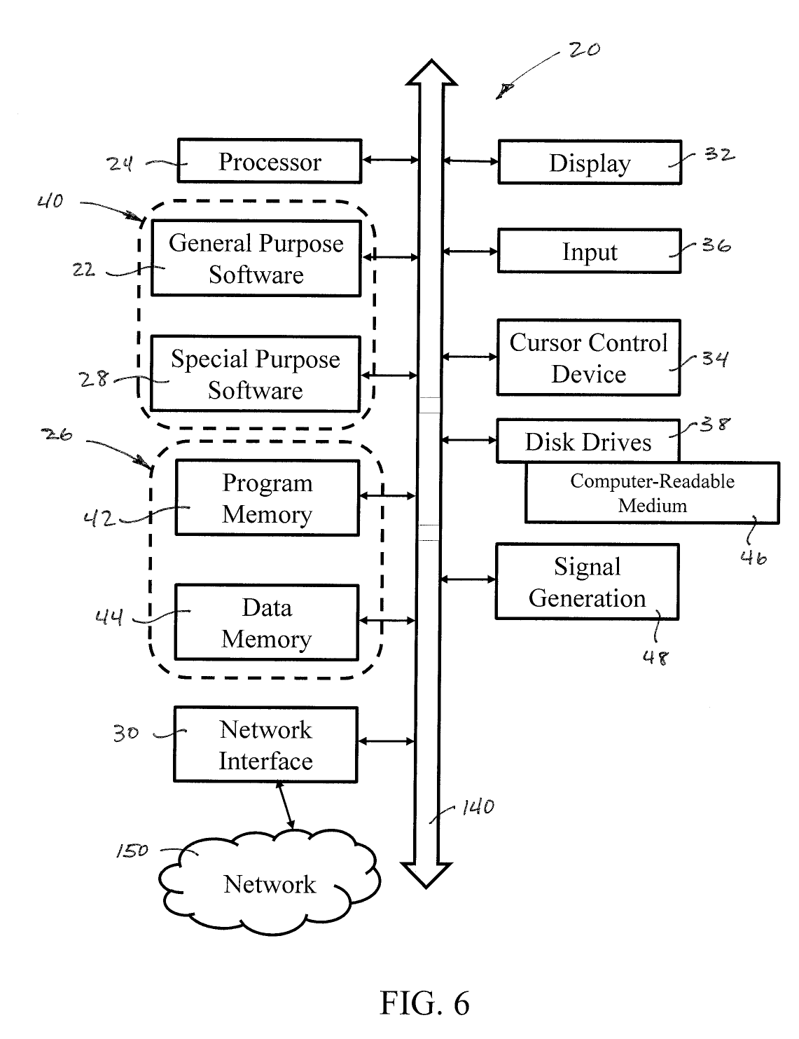

The server 20 has installed and operational thereon general purpose software 22 to carry-out traditional functions of a server (see, e.g., discussion of FIG. 6, below), and special purpose software 28 to carry-out aspects of the present invention, as discussed in more detail herein. The special purpose software 28 renders the server 20 a special purpose computing device insofar as the special purpose software 28 is operably controlling certain functions of the server 20 directed to the present invention. The present invention is thus aimed at solving the technical problem of delivering a surprise digital gift to a gift recipient either in real-time during a cashless transaction, or in advance of the cashless transaction, where the gift can be tailored, in each case, to the intended recipient. The certain functions of the server 20 controlled by the special purpose software 28 are aimed at solving this technical problem which is only possible in accordance with the present invention by the special purpose software 28 together with the general purpose software 22 and server 20 over the network 150. Thus, the present invention is more than a generic computer performing generic, well-understood and routine computer functions.

The system 10 includes a gift database 90 containing separate database entries for gifts for a plurality of gift recipients that are created by a plurality of gifters. Each entry in the gift database 90 corresponds to a cashless transaction account number of a gift recipient and includes at least one gift condition and one gift limitation. The system 10 also has access to a cashless transaction database 92 that includes a plurality of database entries for a plurality of cashless transactions carried out using a plurality of cashless transaction cards. Information in this database 92 provides spending insights about a cardholder including where the cardholder shops most often (e.g., merchants, websites, etc.), the type of products the cardholder buys most often, and other data obtainable from the historical use of the cashless transaction card.

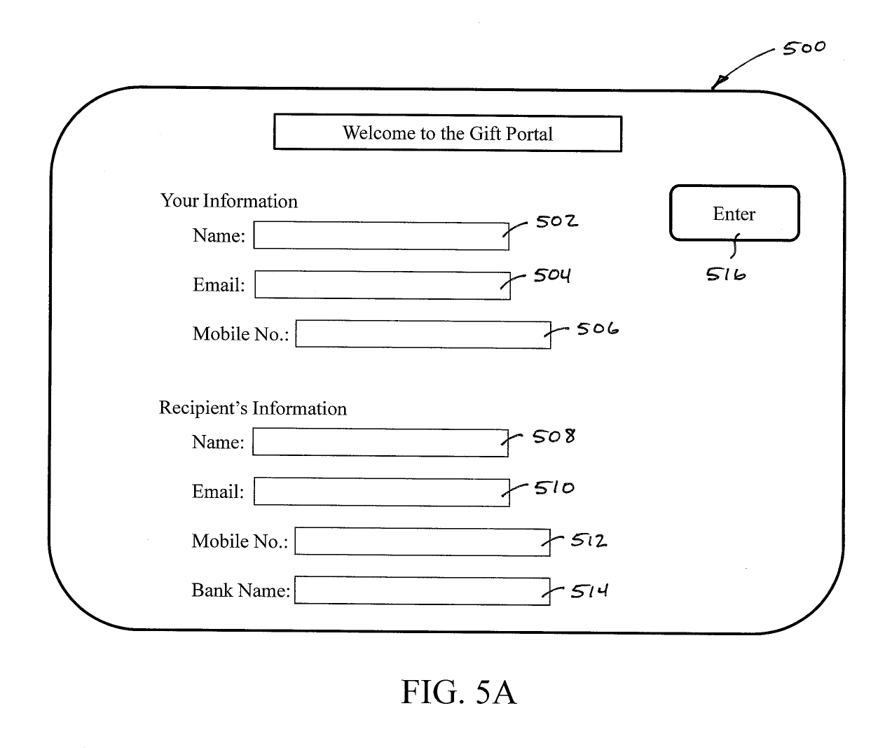

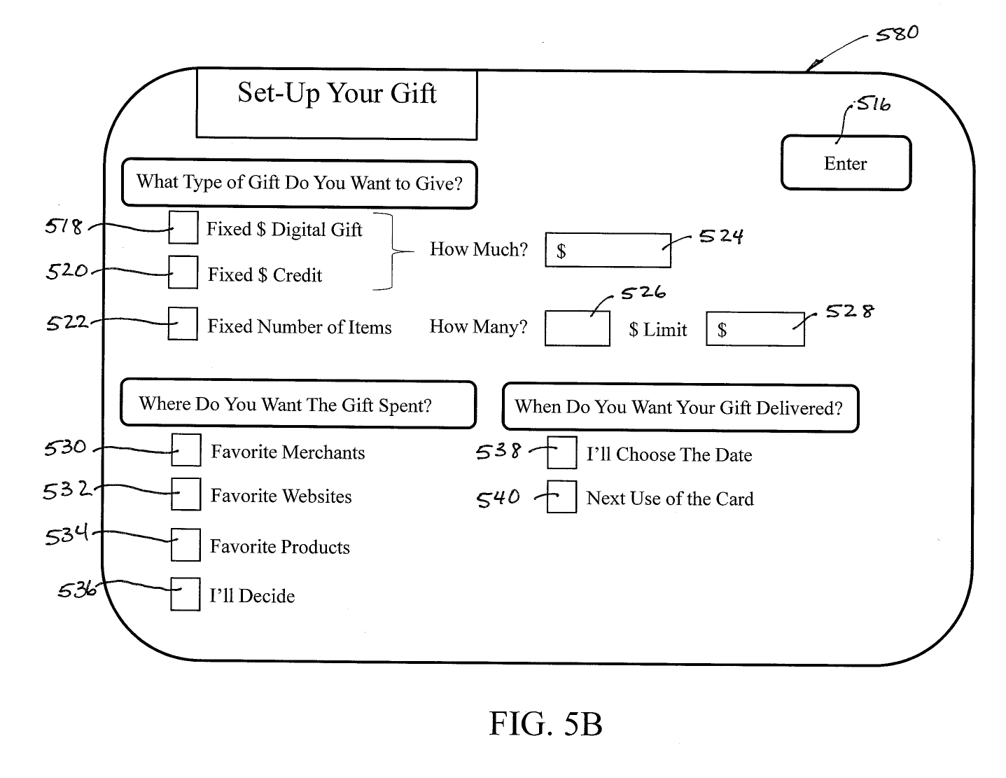

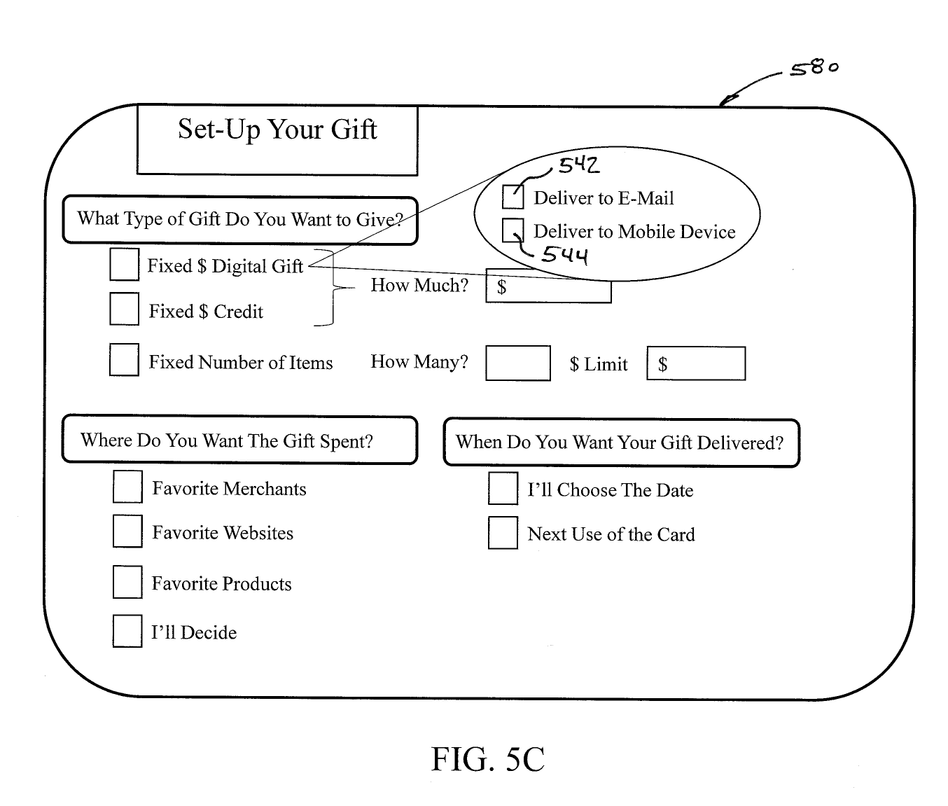

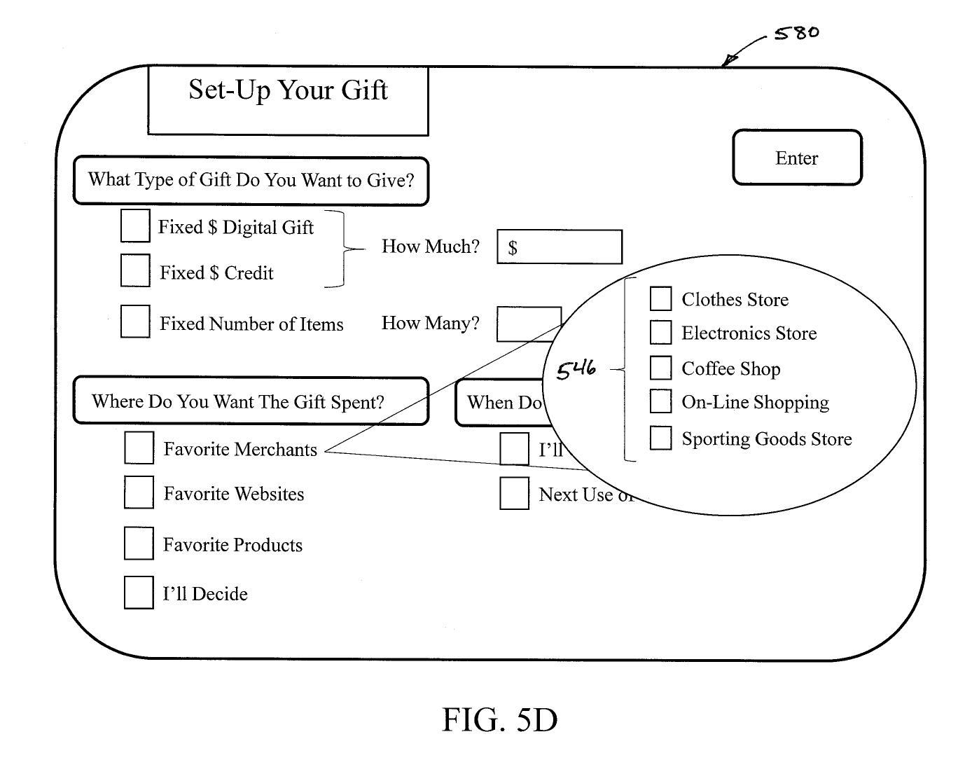

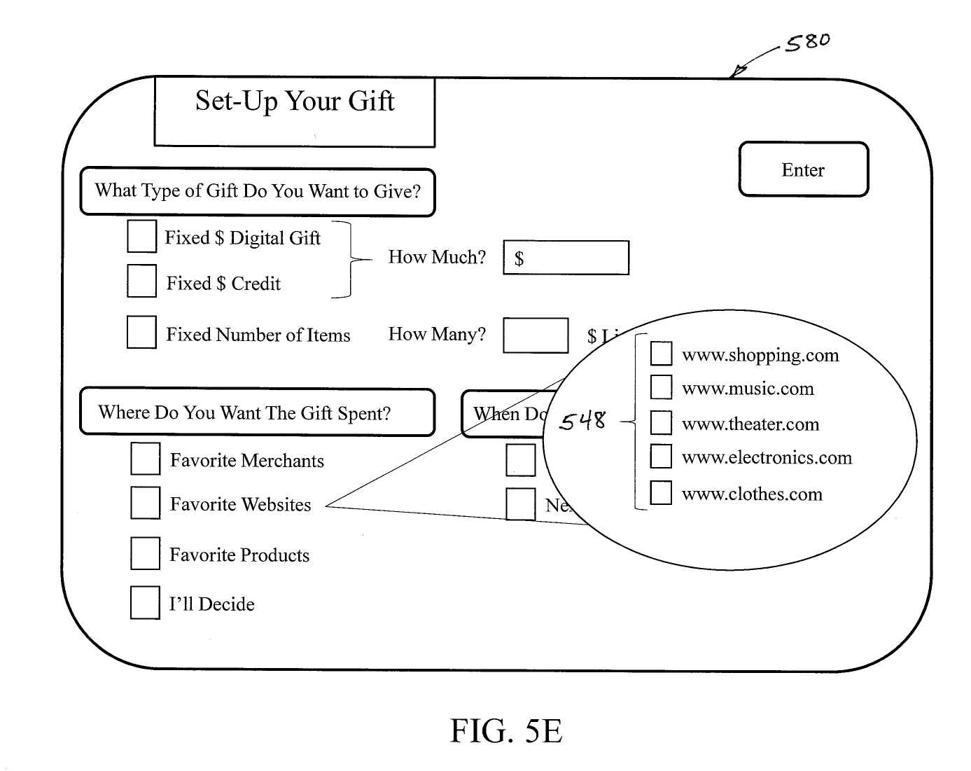

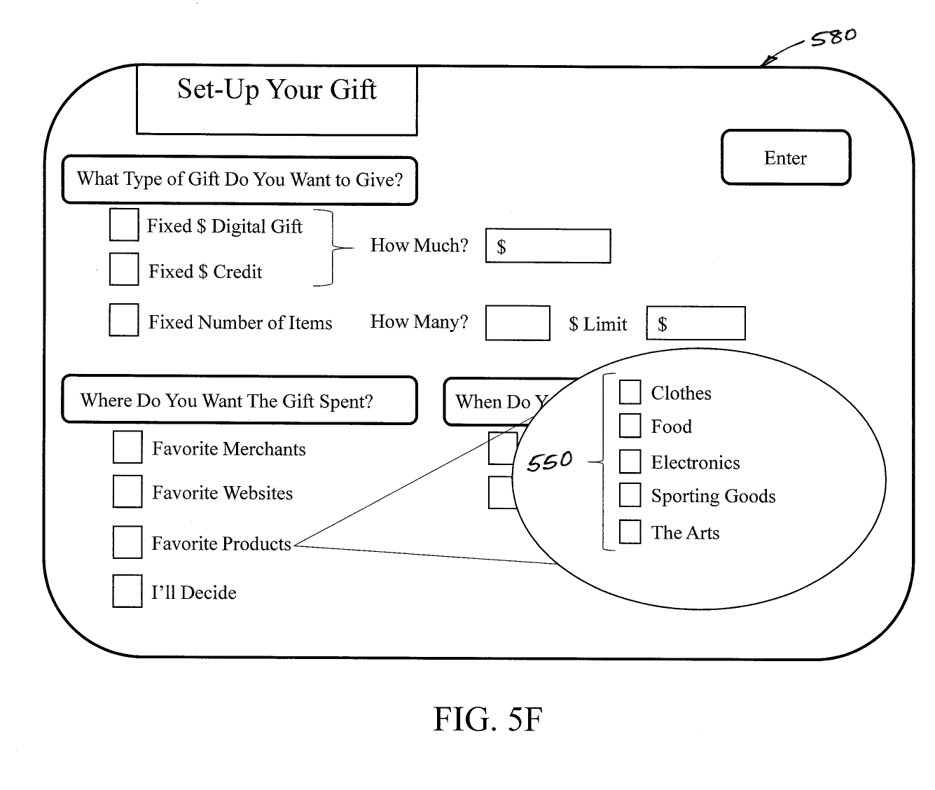

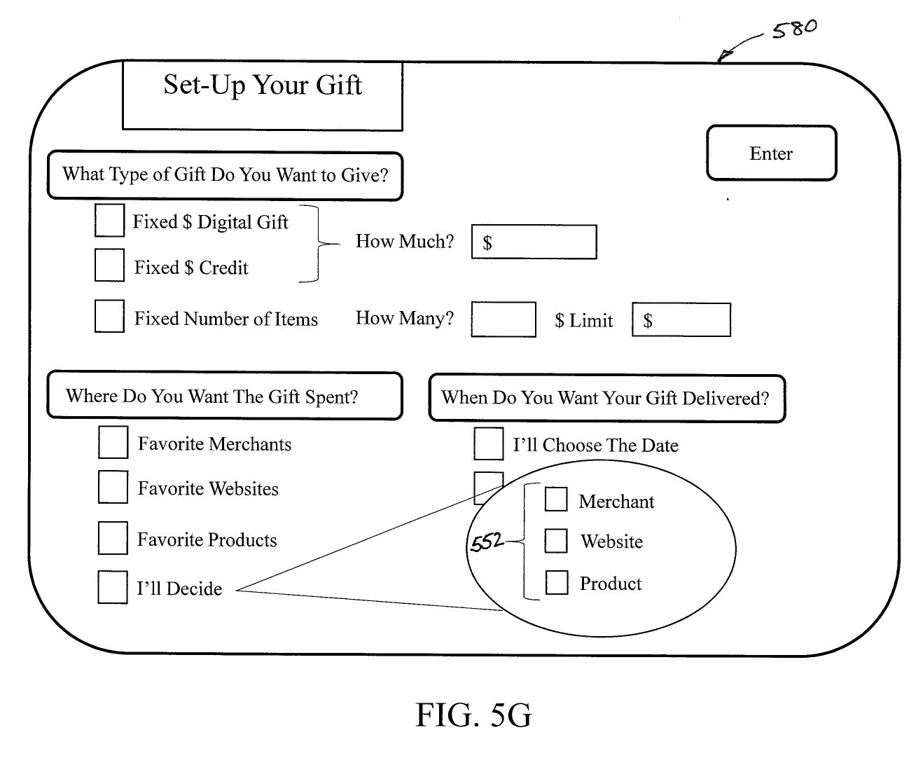

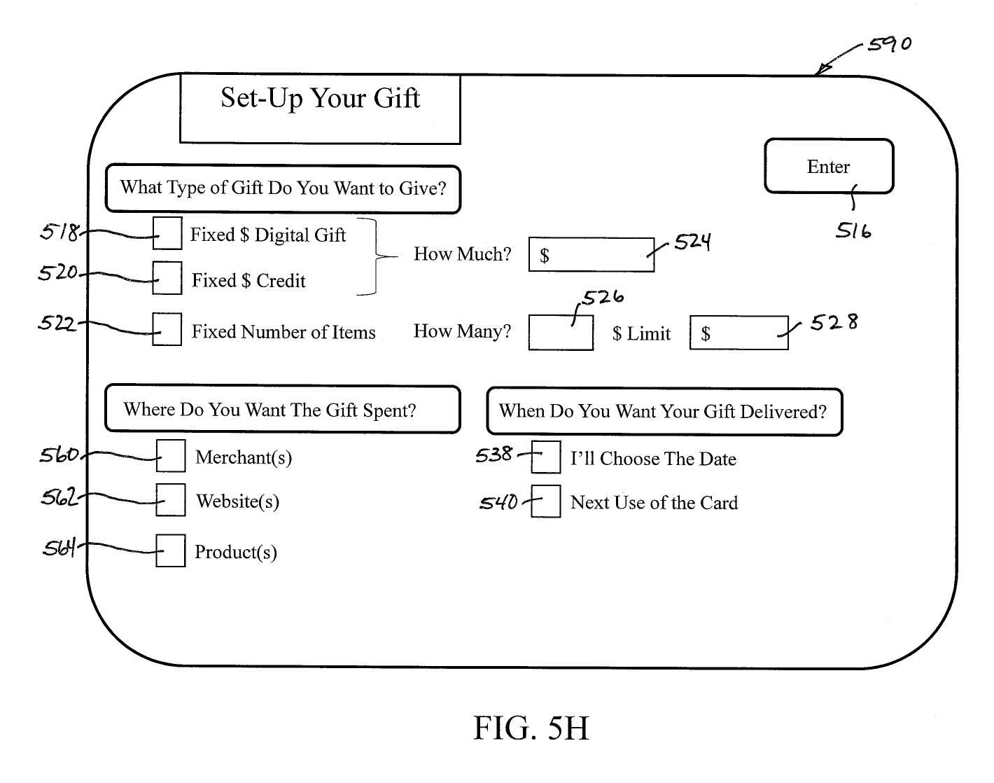

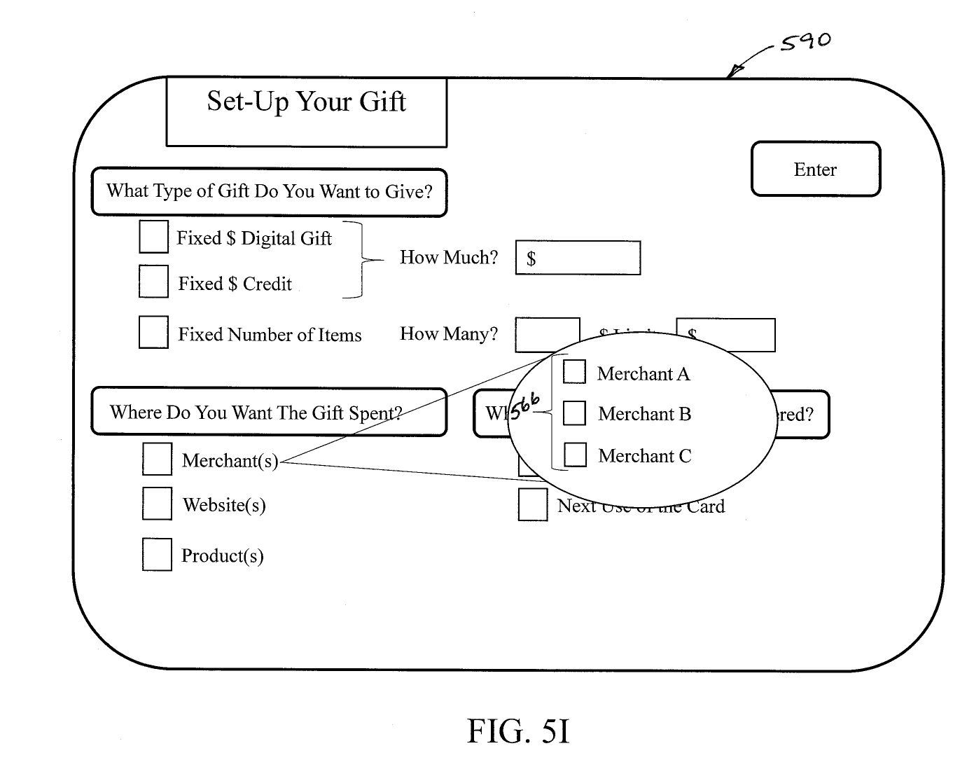

Also shown in FIG. 1 is a gift website 70 that will be described in greater detail in relation to FIGS. 5A-5I.

The server 20 is connectable via the network 150 to at least one point of sale terminal 162 of a merchant 160 that facilitates cashless transactions between the merchant 160 and its customers. The server 20 is also connectable via the network 150 to a merchant website 164 via which a customer may purchase products from the merchant 160 over the network 150. The customer 170 can initiate a cashless transaction using a cashless transaction card 174 at the merchant location via the point of sale terminal 162, or via the merchant website 164 over the Internet (i.e., the network 150). Alternative, the customer 170 may use a mobile device 172 to carry out the cashless transaction, either at the merchant location or via the merchant website 164. The customer mobile device 172 may be a cell phone, smart phone, iPad, tablet, or any other now known or hereafter developed device that enables a user to send and receive information of any type over a network and that is capable of carrying-out a cashless transaction.

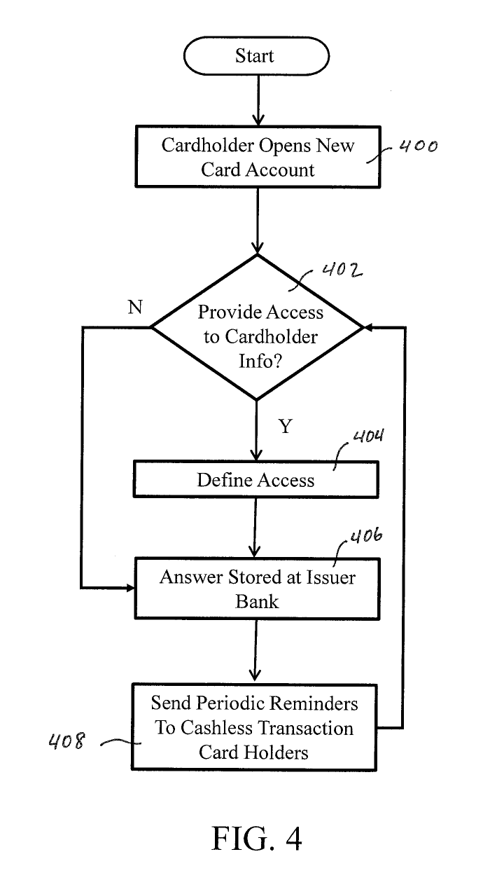

In order for a gifter to be able to set up and deliver a gift to a recipient, the recipient must have previously opened a cashless transaction account with an issuer bank, i.e., a cardholder bank 180 as depicted in FIG. 1 (the recipient thus also being a cardholder). This process is depicted in FIG. 4, where a cardholder opens a new cashless transaction card account at 400. At 402 the cardholder decides whether to allow access to information about the cardholder's account to certain predefined others, e.g., friends, family, etc. In agreeing to allow access, the cardholder authorizes the issuer bank to share certain of the cardholder information with the predefined others. In addition to the cardholder determining whether to provide others with access to the cardholder's information, the cardholder, at 404, defines the type of access to provide. For example, the cardholder could decide to allow the issuer bank to share the cashless transaction card account number, or more limited details such as a favorite merchants list, or last five merchants visited list, favorite products, favorite websites, etc. The choices and decisions of the cardholder are captured and stored by the issuer bank at 406. If the cardholder has initially declined to allow access to information about the cardholder's account, the issuer bank can, at 408, periodically inquire of the cardholder as to whether he/she wants to reconsider that decision. Such inquiry can occur by periodic reminders sent by the issuer bank to the cardholder via e-mail, text message to a cardholder mobile device, or other now known or hereafter developed means and techniques for electronic communication. The issuer bank can set the periodicity of such reminders at its discretion. For example, they may be set with periodic and regular frequency such as, for example, every calendar quarter, as part of a marketing campaign, upon next usage of the cashless transaction card, upon receipt of a first gift for the cashless transaction card, or at other times or situations as determined by the issuer bank.

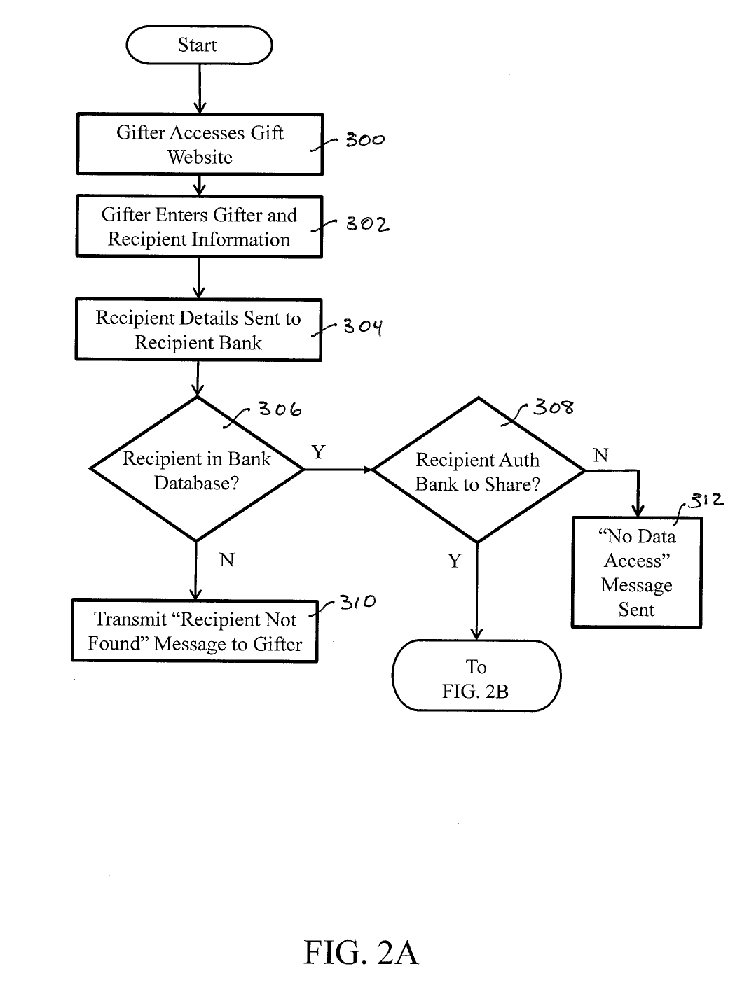

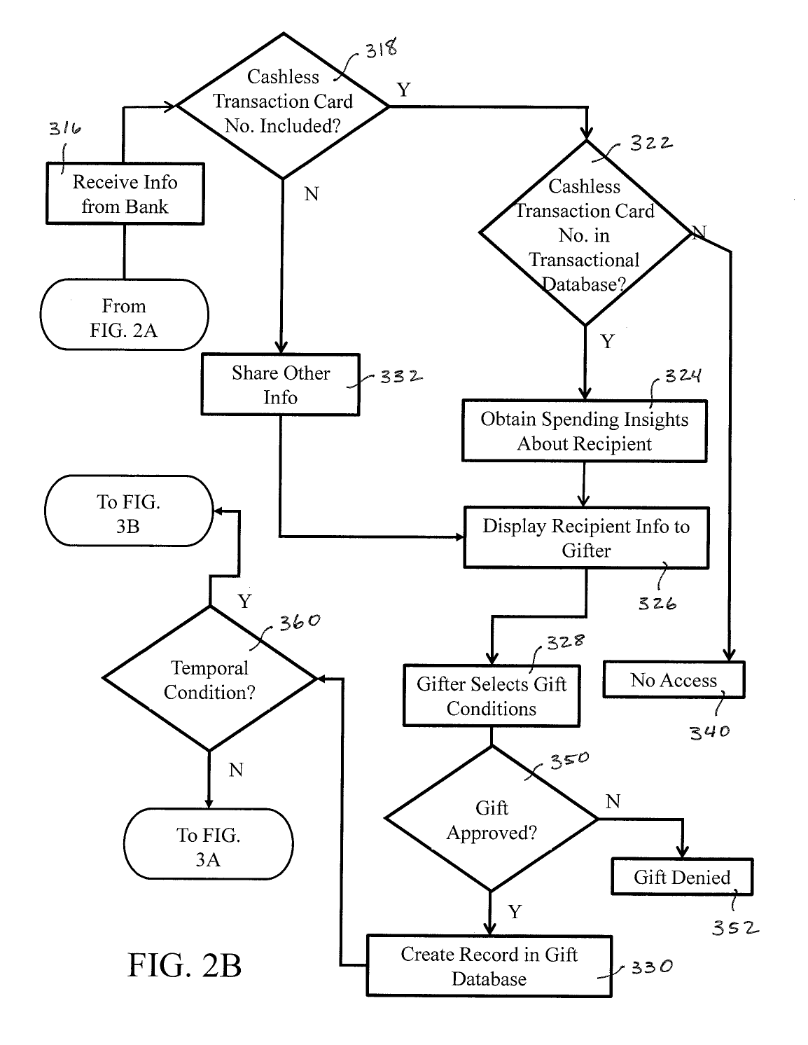

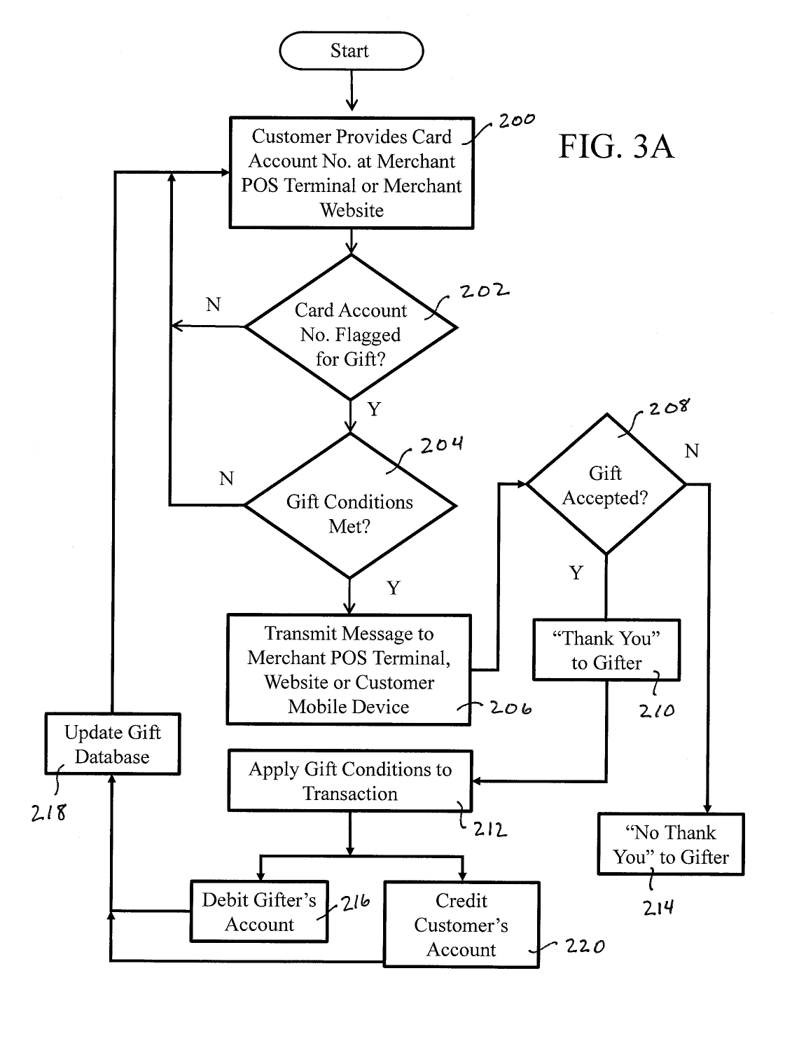

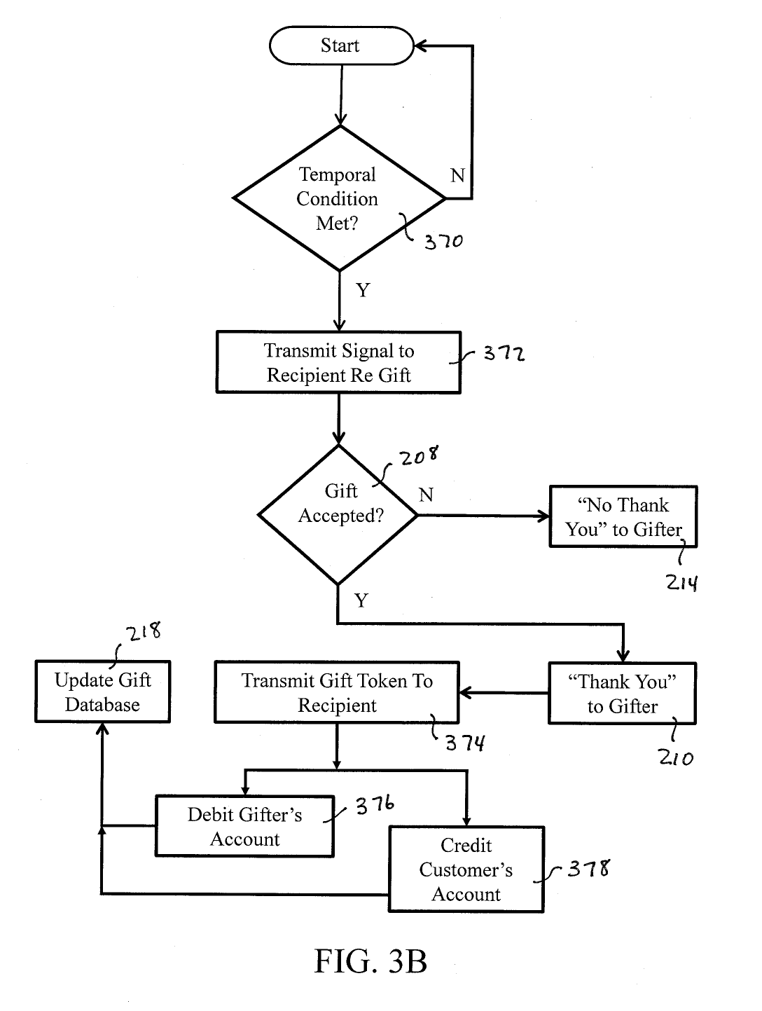

Embodiments of the present invention comprise a gift creation phase (see, e.g., FIGS. 2A, 2B and 5A-5I) and a gift redemption phase (see, e.g., FIGS. 3A and 3B). With reference next to FIGS. FIGS. 2A, 2B and 5A-5I, the gift creation phase of the present invention will now be discussed in greater detail. A person desiring to give a gift using the present invention, referred to herein as a gifter, accesses, at 300, a gift website 500 provided by the special purpose software 28 of the server 20. Via the gift website 500, shown in FIG. 5A, a gifter enters, at 302, certain of his/her information such as, for example, name 502, e-mail address 504, and mobile phone number 506, as well as information about the intended recipient of the gift such as, for example, name 508, e-mail address 510, mobile phone number 512 and bank name 514. As noted above, the intended recipient must have previously opened a cashless transaction account in order for a gift to be created in accordance with the present invention. Once entered, the gifter can select “Enter” 516 to cause, at 304, the information entered to be transmitted by the special purpose software 28 to the intended recipient's bank, which determines, at 306, whether the cardholder has an account at the bank, and if so, at 308 whether the intended recipient has previously agreed to allow his/her information to be shared. If the intended recipient does not have an account at the bank identified by the gifter, a message is returned, at 310, indicating that the intended recipient was not found. If the intended recipient has an account at the bank identified by the gifter, but has not provided permission for the bank to share the intended recipient information, a message is returned, at 312, that access to the intended recipient data is not allowed. If, on the other hand, the intended recipient has an account at the bank identified by the gifter, and has provided permission for the bank to share the intended recipient information, the special purpose software 28 receives the approved information from the intended recipient's bank at 316 of FIG. 2B, and determines if the intended recipient's cashless transaction card account number is included in that information at 318. If the cashless transaction card account number is included, the special purpose software 28 searches the cashless transaction database 92 at 322 to determine if there are entries for the intended recipient's cashless transaction card 174, in which case spending insights for the intended recipient may be obtained, at 324, based upon the intended recipient's historical use of the cashless transaction card. The spending insights may include information about the intended recipient's favorite merchants gleaned from the frequency with which the intended recipient uses his/her cashless transaction card at certain merchants or the amount of money spent at certain merchants. Similarly, spending insights may include information about the type of product(s) the intended recipient likes to buy, or the intended recipient's favorite websites. If, on the other hand, the cashless transaction card account number is not included in the information received from the intended recipient's bank at 316, as determined at 318, other information may be provided by the intended recipient's bank at 332 such as, for example, a list of merchants, websites, products, etc., or other information previously identified by the intended recipient and authorized for sharing.

Once obtained, spending insights or other information may be displayed at 326 on a gift page 580 of the gift website 500, as shown in FIG. 5B, where the gifter continues to create the gift by entering gift conditions such as, by way of non-limiting example, purchase and temporal conditions, one or more gift limitations, and delivery options at 328. The gifter is provided with three choices for the type of gift: a fixed dollar amount digital gift 518, a fixed dollar amount credit 520, and a fixed number of items 522 that may be limited in quantity 526 and by dollar amount 528. Similarly, the amount of the fixed dollar amount digital gift 518 and fixed dollar amount credit 520 can be limited 524 by the gifter.

The gifter may also choose where the gift may be spent. The gift page 580 depicted in FIGS. 5B-5G is presented when information regarding spending insights for the intended gift recipient is shared with the gifter. In accordance with embodiments of the present invention, the gifter does not have direct access to or directly receive information regarding spending insights for the intended gift recipient. Rather, the special purpose software 28 of the server 20, having accessed spending insight information about the intended gift recipient on the cashless transaction database 92, analyzes that information and presents certain limited aspects of that information to the gifter via the gift page 580, as discussed in more detail below with reference to FIGS. 5B-5G. The spending insights may identify the intended recipient's favorite merchants 530, websites 532 and products 534. The gifter can select favorite merchants 530, for example, and be provided with a list 546 of the intended recipient's favorite merchants, as shown in FIG. 5D, from which the gifter can select at least one. Alternatively, the gifter can select favorite websites 532 and be provided with a list 548 of the intended recipient's favorite websites, as shown in FIG. 5E, from which the gifter can select at least one. Likewise, the gifter can select favorite products 534 and be provided with a list 550 of the intended recipient's favorite products, as shown in FIG. 5F, from which the gifter can select at least one. The gifter can also decide the merchant, website or product by selecting “I'll Decide” 536, and by selecting one of merchant, website or product from the list 552, and then enter details for the selection, as shown in FIG. 5G.

The gift page 580 also enables that gifter to select when the gift will be delivered, by choosing a date certain (e.g., a birthday or holiday) or a range of dates (e.g., for the month of June) 538 or upon next use of the card 540, for example. The fixed dollar amount digital gift 518 is preferably delivered to the gift recipient separate from the recipient's participation in a cashless transaction, i.e., in advance of the time it is used by the gift recipient. For example, this gift type may be temporally conditioned for delivery on the gift recipient's birthday, a holiday, during a certain time frame, or as otherwise time-conditioned by the gifter. The gifter may choose delivery of this gift type via e-mail 542, text to a mobile device 544, or other now known or hereafter developed means of digital communication, as shown in FIG. 5C. The fixed dollar amount credit 520 and the fixed number of items 522 gift types are preferably delivered to the gift recipient during the cashless transaction and to the merchant point of sale terminal, merchant website, and/or to the gift recipient's mobile device and/or e-mail account. In this way the gifter can surprise the gift recipient during a cashless transaction. Timing for the delivery of these gift types may also be selected by the gifter. In addition, the gifter can prioritize the temporal conditions with other gifter-selected purchase conditions. Other options for method and timing for delivery of the gift are also contemplated by, and within the scope and spirit of the present invention.

Referring again to FIG. 2B, the intended recipient may have previously decided to allow his/her bank to share certain information with others, but not a cashless transaction card number. For example, the intended recipient may have authorized his/her bank to provide a list of favorite merchants or products to others. Thus, at 318, the special purpose software 28 of the server 20 determines if the intended recipient's cashless transaction account number is included in the information returned from the bank, and if it's not, the bank returns, at 332, other information for the intended recipient that may be displayed on a gift page 590 of the gift website 500, as shown in FIG. 5H. In this case, the other information may include identification of the intended recipient's favorite merchants, products, or websites, by way of non-limiting example. Here, the gifter can select one or more category of Merchant(s) 560, Website(s) 562, or Product(s) 564, a selection of one of which will cause a list of merchants 566 to be displayed of the intended recipient's favorites in each category, as shown in FIG. 5I. The gifter can select one or more of the favorites on the merchant list 566. Other aspects of the gift page 590 of are similar to those discussed in connection with FIGS. 5B-5G.

Once the gifter selects the gift conditions, as per FIGS. 5A-5I and 328 of FIG. 2B, the special purpose software 28 determines if the gift is approved at 350 by verifying with the gifter's bank 182 the ability of the gifter to satisfy the debt obligation created by the gift by considering, by way of illustration and not limitation, the amount of the gift, amount of money available in gifter's account (e.g., credit limit for credit card and checking account balance for debit cards), status of gifter's account, gifter's payment history, etc. For a gift having a variable dollar amount (i.e., one for a fixed number of items), the approval process considers an average spending by the intended recipient for the cashless transaction account number and uses that number when considering the gifter's ability to satisfy the gift obligation. If authorization fails, the gift is denied at 352. If the gift is authorized, the special purpose software 28 creates a record, at 330, of the gift in the gift database 90. In this case, no clearing is done until the intended recipient accepts or uses the gift during a cashless transaction.

The special purpose software 28 then determines at 360 whether a temporal condition is a part of the gift. If it is, the present invention proceeds to FIG. 3B; if it is not, to FIG. 3A.

Referring next to FIGS. 3A and 3B, the gift redemption phase of the present invention will now be further discussed in more detail. In FIG. 2B, when the special purpose software 28 determines a temporal condition was not a part of the gift, the present invention proceeds according to FIG. 3A. A cashless transaction is initiated, at 200, by a customer swiping a cashless transaction card or using a cashless transaction device at a merchant point of sale terminal, or by entering a cashless transaction card number at a merchant website. The server 20 receives the initiation of the cashless transaction and the special purpose software 28 determines, at 202 and by accessing the gift database 90, whether there is an entry in that database for the cashless transaction card number being used for the cashless transaction, i.e., whether that card has been flagged for a gift. If the card is not flagged for a gift, the cashless transaction will proceed as usual without further involvement of the present invention. If there is an entry for the cashless transaction card, the special purpose software 28 determines, at 204, whether any conditions for the gift have been met. For example, if the gift was created for use only at a specified merchant, the special purpose software 28 determines if this transaction is with that merchant. If the gift conditions are not met, the cashless transaction will proceed as usual without further involvement of the present invention. If the gift conditions are met, the special purpose software 28, at 206, will cause a message to be transmitted to the merchant point of sale terminal 162, merchant website 164, or to the customer via e-mail or text to advise the customer of the gift and to provide the customer with the option, at 208, to accept or reject the gift. If the special purpose software 28 receives a message that the gift is accepted, a “Thank You” message is sent, at 210, via text, e-mail, or other now known or hereafter developed communication method, technique or system to the gifter. If, on the other hand, the gift is rejected, a “No Thank You” message is sent, at 214, to the gifter. If the customer accepts the gift, the conditions of the gift are applied to the transaction so as to modify the transaction according to the conditions of the gift at 212, and the gifter's bank account is debited for the amount of the gift, at 216, or the customer's cashless transaction card account number will be credited at 220, depending upon whether the gift was a cash or credit gift. Finally, the special purpose software 28 updates the gift database 90 to reflect acceptance and use of the gift by the customer.

In FIG. 2B, when the special purpose software 28 determines a temporal condition was a part of the gift, the present invention proceeds according to FIG. 3B. After determining that the temporal condition has been met at 370, the special purpose software 28 transmits, at 372, a signal to the recipient to inform the recipient of the gift and to give the recipient the option, at 208, of accepting or rejecting the gift. If the special purpose software 28 receives a message that the gift is accepted, a “Thank You” message is sent, at 210, via text, e-mail, or other now known or hereafter developed communication method, technique or system to the gifter. If, on the other hand, the gift is rejected, a “No Thank You” message is sent, at 214, to the gifter. If the recipient accepts the gift, a gift token is transmitted, at 374, to the recipient vie text or e-mail. The recipient can use the gift token according to its conditions, as defined by the gifter when creating the gift. When the recipient uses the gift token, the gifter's account is debited, at 376, or the recipient's cashless transaction card account number will be credited at 378, depending upon whether the gift was a cash or credit gift. Finally, the special purpose software 28 updates the gift database 90 to reflect acceptance and use of the gift by the recipient.

In an embodiment of the present invention, a gift recipient can accept and use the gift, but without completely exhausting the amount of the gift. For example, a gifter may create a gift in the amount of $100 to be spent at Merchant A, and the recipient accepts the gift but only spends $50 at Merchant A. In FIGS. 3A and 3B, at 216/220 and 376/378, respectively, the gifter's account will be debited $50 and, at 218, the gift database 90 will be updated to reflect that the gift is still in effect and the amount is now $50. The other conditions set by the gifter when creating the gift remain in effect, e.g., the gift may only be used at Merchant A, and the balance of the gift may be applied to a subsequent cashless transaction carried-out by the gift recipient according to the conditions of the gift as set by the gifter.

With continued reference to FIG. 1, and additional reference to FIG. 6, a server 20 in accordance with embodiments of the present invention will now be discussed in more detail. The server 20 may be a general purpose computing device having a plurality of devices and components operably connected over a bus 140. The server 20 has one or more processors 24 or central processing units (“CPU”). Although the server 20 of the present invention is discussed as having a single processor 24, a server having multiple processor, either separate or integrated in a multi-core processor, for example, are also contemplated by and within the scope and spirit of the present invention. Reference to processor in the singular herein shall be interpreted to include any variation and number of processors. The processor 24 is operable by at least one program of instructions 40 comprising general purpose software 22 to carry out functions that enable the server 20 to interface with its various hardware components (discussed further below), and to interface and communicate with other devices. The processor 24 of the present invention is also operable by at least one program of instructions 40 comprising special purpose software 28 to carry out aspects of the present invention. The general purpose software 22 and special purpose software 28 may be stored on the server 20 in memory 26 that may comprise program memory 42 and data memory 44, or it may be stored on one or more disk drives 38 comprised of a computer-readable medium 46, or it may be stored in/on any combination of the foregoing. As used herein, the term “memory” is intended to include all currently known or hereafter developed types of permanent or temporary storage devices or components in a computing device. Exemplary memory types include, by way of illustration and not limitation, Random Access Memory (RAM)—further including Dynamic RAM (DRAM), Static RAM (SRAM), and Direct Rambus DRAM (DRDRAM), Read Only Memory (ROM)—further including Programmable ROM (PROM), erasable PROM (EPROM), and Electrically EPROM (EEPROM), cache memory, hard drives and flash memory.

The server 20 further includes a display 32 (e.g., liquid crystals display (LCD), a flat panel, a solid state display, or a cathode ray tube (CRT)), input device(s) 36 (e.g., a keyboard), cursor control device(s) 34 (e.g., a mouse), signal generation device(s) 48 (e.g., a speaker or remote control), and network interface device(s) 30 that enable the server 20 to selectively connect to and with a network 150 and send or receive voice, video or data, and to communicate over the network 150 as controlled by the program of instructions 40.

The memory 26 and disk drives 38 each comprise computer-readable medium 46 that may each include a single medium or multiple media (e.g., a centralized or distributed database, and/or associated caches and servers) that store the one or more sets of instructions 40. The term “computer-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives that is considered a distribution medium equivalent to a tangible storage medium. Accordingly, the embodiment is considered to include anyone or more of a tangible computer-readable medium or a tangible distribution medium, as listed herein and including art-recognized equivalents and successor media, in which the software implementations herein are stored. The term “computer-readable medium” shall also be taken to include any medium that is capable of storing, encoding, or carrying a set of instructions in the general purpose software 22 and in the special purpose software 28.

In a particular non-limiting, example embodiment, the computer-readable medium 46 can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification may describe components and functions implemented in the embodiments with reference to particular standards and protocols, the disclosed embodiments are not limited to such standards and protocols.

In accordance with various embodiments, the present invention may be implemented as one or more software programs running on one or more computing devices and one or more computer processors. Dedicated hardware implementations including, but not limited to, application specific integrated circuits, programmable logic arrays and other hardware devices can likewise be constructed to implement the present invention. Furthermore, alternative software implementations including, but not limited to, distributed processing or component/object distributed processing, parallel processing, or virtual machine processing can also be constructed to implement the present invention.

Modifications to embodiments of the present invention are possible without departing from the scope of the invention as defined by the accompanying claims. Expressions such as “including,” “comprising,” “incorporating,” “consisting of,” “have,” “is,” used to describe and claim the present invention are intended to be construed in a non-exclusive manner, namely allowing for items, components or elements not explicitly described herein also to be present. Reference to the singular is to be construed to relate to the plural, where applicable.

Throughout the description, where items are described as having, including, or comprising one or more specific components, or where methods are described as having, including, or comprising one or more specific steps, it is contemplated that, additionally, there are items of the present invention that consist essentially of, or consist of, the one or more recited components, and that there are methods according to the present invention that consist essentially of, or consist of, the one or more recited processing steps.

As will be appreciated by one skilled in the art, the present invention may be embodied as a system, method, or computer program product. Accordingly, the present invention may comprise hardware element(s), software element(s) (including firmware, resident software, micro-code, etc.), or a combination of hardware and software elements that may generally be referred to herein as a “server,” “computing system,” “computer system,” “system,” etc. It is commonly known in the art these devices may be associated with one or more processors or central processing units. Furthermore, the present invention may take the form of a computer program product embodied in any tangible medium of expression having computer usable program code embodied in the medium.

Computer software (i.e., computer program code, applications, etc.) for carrying out aspects of the present invention may be written in any combination of one or more programming languages, including an object-oriented programming language such as Java, Smalltalk, C++, or the like and conventional procedural programming languages, such as Visual Basic, “C,” or similar programming languages, it being obvious to a person skilled in the art that embodiments of the present invention are not dependent upon a specific or particular type of software or application code.

The present invention is described below with reference to flowchart illustrations and/or block diagrams of methods, apparatuses (systems), and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be stored in memory of a general purpose computer, special purpose computer, or other programmable data processing apparatus to produce a machine, such that the instructions, which execute via the processor of the computer or other programmable data processing apparatus, implement aspects of the present invention as depicted in the flowchart and/or block diagrams. The computer program instructions comprise general purpose software and special purpose software, the latter of which renders the computer a special purpose computing device insofar as the special purpose software is operably controlling certain functions of the computer directed to the present invention. These computer programmable instructions may also be stored in a computer-readable medium that may comprise a part of the computer or that may be loadable onto the computer and that can direct a computer or other programmable data processing apparatus to function in a particular manner, such that the instructions stored in the computer-readable medium produce an article of manufacture including instruction means which implement the function/act specified in the flowchart and/or block diagram.

What is claimed is:

1. A system for delivering a cashless gift useable during a cashless transaction between a merchant and a customer using a cashless transaction account number, the system comprising:
a gift database having a plurality of database entries, each of the plurality of database entries being for a gift created by a gifter, each gift corresponding to a cashless transaction account number and having at least one gift condition and at least one gift limitation;
a server having a processor operable by a program of instructions stored in memory, the server being connectable to the gift database and at least one of a point of sale terminal and a merchant website, the program of instructions, when executed by the server processor, causes the server processor, during a cashless transaction, to:
receive an initiation of the cashless transaction for the customer cashless transaction account number;
determine if there is an entry in the gift database corresponding to the customer cashless transaction account number;
if there is an entry in the gift database corresponding to the customer cashless transaction account number, determine if the at least one gift condition has been met;
determine if the customer has accepted the gift;
if the customer has accepted the gift, apply, to and during the cashless transaction, at least one of the at least one gift condition and the at least one gift limitation; and
update the entry in the gift database corresponding to the customer cashless transaction account number.

2. A system according to claim 1, wherein the at least one gift condition identifies a location at which the gift may be redeemed, and wherein the location comprises one of a merchant location, a merchant website, a favorite merchant of the customer, a favorite website of the customer, a merchant selected by the gifter, and a website selected by the gifter.

3. A system according to claim 1, wherein the at least one gift condition defines a type of gift, and wherein the type of gift comprises one of a fixed monetary amount gift, a fixed credit amount gift, and a fixed number of items gift.

4. A system according to claim 3, wherein the type of gift comprises a fixed monetary amount gift delivered to the customer at a time chosen by the gifter and usable by the customer during the cashless transaction at one of a merchant chosen by the customer and a merchant chosen by the gifter, wherein the fixed monetary amount is applied during the cashless transaction to reduce the amount of the cashless transaction by the fixed monetary amount.

5. A system according to claim 4, wherein the gift limitation comprises one of a maximum dollar amount and a dollar range.

6. A system according to claim 3, wherein the gift is delivered to the customer in advance of the initiation of the cashless transaction.

7. A system according to claim 3, wherein the type of gift comprises a fixed credit amount gift delivered to the during the cashless transaction and usable by the customer during the cashless transaction at one of a merchant chosen by the customer and merchant chosen by the gifter, wherein the fixed credit amount is applied as a credit to the cardholder cashless transaction account number.

8. A system according to claim 7, wherein the gift limitation comprises one of a maximum dollar amount and a dollar range.

9. A system according to claim 3, wherein the type of gift comprises a fixed number of items gift delivered to the customer during the cashless transaction and usable by the customer during a cashless transaction at one of a merchant chosen by the customer and merchant chosen by the gifter, wherein the fixed number of items gift is applied during the cashless transaction to reduce the amount owed by the customer for the cashless transaction to zero for a number of items defined by the fixed number of items gift.

10. A system according to claim 9, wherein the gift limitation comprises one of a maximum number of items and a number range of items.

11. A system according to claim 1, wherein the at least one gift condition defines a product category comprising one of a favorite product category of the customer and a product category selected by the gifter.

12. A system according to claim 1, wherein the program of instructions, when executed by the server processor, further causes the server processor to:
provide a gift website and receive from a gifter accessing the gift website first information about a gift recipient;
transmit the first information to a bank of the gift recipient;
receive from the bank of the gift recipient second information about the gift recipient;
receive, from the gifter via the gift website, terms for a gift for the gift recipient; and
create a record in the gift database for the gift.

13. A system for delivering a cashless gift useable during a cashless transaction between a merchant and a customer using a cashless transaction account number, the system comprising:
a gift database having a plurality of database entries, each of the plurality of database entries being for a gift created by a gifter, each gift corresponding to a cashless transaction account number and having at least one temporal condition, at least one gift condition, and at least one gift limitation;
a server having a processor operable by a program of instructions stored in memory, the server being connectable to the gift database and at least one of a point of sale terminal and a merchant website, the program of instructions, when executed by the server processor, causes the server processor to:
determine if the temporal condition has been met;
determine if the customer has accepted the gift;
if the customer has accepted the gift, transmit a gift token to the gift recipient;
during a cashless transaction, when the customer uses the gift token, apply at least one of the at least one gift condition and the at least one gift limitation; and
update the entry in the gift database corresponding to the customer cashless transaction account number.

14. A system according to claim 13, wherein the at least one temporal condition is one of a date and a range of dates.

15. A system according to claim 13, wherein the at least one gift condition defines a type comprising one of a fixed monetary amount gift, a fixed credit amount gift, and a fixed number of items gift.

16. A system according to claim 15, wherein the type of gift comprises a fixed monetary amount gift delivered to the customer at a time chosen by the gifter and usable by the customer during the cashless transaction at one of a merchant chosen by the customer and a merchant chosen by the gifter, wherein the fixed monetary amount is applied during the cashless transaction to reduce the amount of the cashless transaction by the fixed monetary amount.

17. A system according to claim 16, wherein the gift limitation comprises one of a maximum dollar amount and a dollar range.

18. A system according to claim 15, wherein the type of gift comprises a fixed credit amount gift delivered to the during the cashless transaction and usable by the customer during the cashless transaction at one of a merchant chosen by the customer and merchant chosen by the gifter, wherein the fixed credit amount is applied as a credit to the cardholder cashless transaction account number.

19. A system according to claim 18, wherein the gift limitation comprises one of a maximum dollar amount and a dollar range.

20. A system according to claim 15, wherein the type of gift comprises a fixed number of items gift delivered to the customer during the cashless transaction and usable by the customer during a cashless transaction at one of a merchant chosen by the customer and merchant chosen by the gifter, wherein the fixed number of items gift is applied during the cashless transaction to reduce the amount owed by the customer for the cashless transaction to zero for a number of items defined by the fixed number of items gift.

21. A system according to claim 20, wherein the gift limitation comprises one of a maximum number of items and a number range of items.

22. A system according to claim 13, wherein the at least one gift condition defines a product category comprising one of a favorite product category of the customer and a product category selected by the gifter.

23. A system according to claim 13, wherein the at least one gift condition identifies a location at which the gift may be redeemed, and wherein the location comprises one of a merchant location, a merchant website, a favorite merchant of the customer, a favorite website of the customer, a merchant selected by the gifter, and a website selected by the gifter.

24. A system according to claim 13, wherein the program of instructions, when executed by the server processor, further causes the server processor to:
provide a gift website and receive from a gifter accessing the gift website first information about a gift recipient;
transmit the first information to a bank of the gift recipient;
receive from the bank of the gift recipient second information about the gift recipient;
receive, from the gifter via the gift website, terms for a gift for the gift recipient; and
create a record in the gift database for the gift.
